(19) United States
(12) Patent Application Publication
(10) Pub. No.: US 2007/0005784 A1
(43) Pub. Date: Jan. 4, 2007

(54) BGP dynamic AS renumbering

(76) Inventors: Susan K. Hares, Saline, MI (US); Pratik Bose, Gaithersburg, MD (US)

Correspondence Address: PERKINS COIE LLP, P.O. BOX 2168, MENLO PARK, CA, 94026, US

(21) Appl. No.: 11/354,289

(22) Filed: Feb. 13, 2006

Related U.S. Application Data
(60) Provisional application No. 60/652,395, filed on Feb. 11, 2005.

(51) Int. Cl. G06F 15/16

(52) U.S. Cl. 709/230

(57) ABSTRACT

This invention has two mechanisms: Dynamic AS switching for AS confederations and Dynamic AS switching. The Dynamic AS switching for AS confederation mechanism provides a mechanism for an Autonomous System within an AS confederation to survive disconnection from the rest of the Autonomous Systems within the AS Confederation. This invention provides a mechanism for the AS within the AS confederation to use a pre-agreed upon fail-over to the internal AS, so its eBGP connections will not be reset. The Dynamic AS switching mechanisms allows to peers to re-negotiate AS number changes in any Autonomous Systems the peer represent without dropping the BGP peering session.

This application claims the benefit of U.S. Provisional Application No. 60/652,395, filed Feb. 11, 2005, U.S. patent application Ser. No. 11/122,991, filed May 4, 2005, U.S. Provisional Application No. 60/568,079, filed on May 4, 2004, and U.S. Provisional Application No. 60/506,018, filed on Sep. 24, 2003 all of which are herein incorporated by reference.

### FIELD OF THE INVENTION

The present invention relates generally to communication networks and, more particularly, to a method and apparatus for exchanging information via the Border Gateway Protocol.

### BACKGROUND

In the basic BGP protocol, BGP speaker announces all routes permitted by BGP policy to peers. Each BGP speaker identifies itself with an Autonomous System number.

BGP AS Confederations provide a method to scale the BGP infrastructure. Several Autonomous Systems with BGP may band together within an Autonomous System (AS) Confederation. To the rest of the BGP infrastructure, the AS-es within the BGP Confederation appear as a single AS. Within the AS confederations, these BGP peers exchange External BGP (EBGP) sessions with other AS-es using their internal AS number. AS BGP peers establish sessions outside the BGP confederation, the BGP peers use the AS Confederation AS in their BGP AS.

### 1. Description of the Problem Solved by the Invention

A BGP peer that acts as a hub for a large number of AS peers may cause significant outages when taking down a peer session. Two examples of AS that may lose peers are an AS that is on the edge of a Confederation, and an AS that is not in a confederation but forms a hub for a group for a group of external peers.

When an AS is connected to the rest of an AS confederation, it acts as a single AS. If all links between the AS to other members of the AS confederation are broken, the AS Confederation is broken in two (or more) parts, and the individual sub-Autonomous Systems (sub-AS-es) within the confederation may need to “back off” to their local AS number to restore connectivity through some external path.

If a router along the edge of an AS determines the sub-AS has lost its connection to the remainder of the confederation AS, it will need to change the AS number with which it is peering to eBGP peers. This restart of all EBGP connections can be onerous for the AS that has broken away from the AS Confederation.

The internal AS in the AS confederation may still be able to communicate with the BGP infrastructure using a different pathway, but cannot use alternate paths due to the AS confederation split.

If a BGP peer on the Edge of AS confederation re-connects from the AS Confederation in to the AS-Confederation, the AS confederation is healed. Any solution that handles the splitting of the AS Confederation must also allow for the restoration of the AS confederation to it's original state. Diagram 1 shows the AS Confederation case.

An As that forms a NUB for a number of peers, the dropping of a peer session will cause all attached peers to drop their routes. FIG. 2 shows the fan-in for a large number of BGP peers. If the BGP peer session is dropped solely for re-assigning the AS number, the outage is unnecessary.

### SUMMARY OF THE INVENTION

This invention has two mechanisms: Dynamic AS switching for AS confederations and Dynamic AS switching. The Dynamic AS switching for AS confederation mechanism provides a mechanism for an Autonomous System within an AS confederation to survive disconnection from the rest of the Autonomous Systems within the AS Confederation. This invention provides a mechanism for the AS within the AS confederation to use a pre-agreed upon fail-over to the internal AS, so its eBGP connections will not be reset.

The Dynamic AS switching mechanisms allows to peers to re-negotiate AS number changes in any Autonomous Systems the peer represent without dropping the BGP peering session.

### BRIEF DESCRIPTION OF THE FIGURES

FIG. 1 illustrates an AS confederation FAN-IN in accordance with embodiments of the invention.

FIG. 2 illustrates an AS FAN-IN without confederation in accordance with embodiments of the invention.

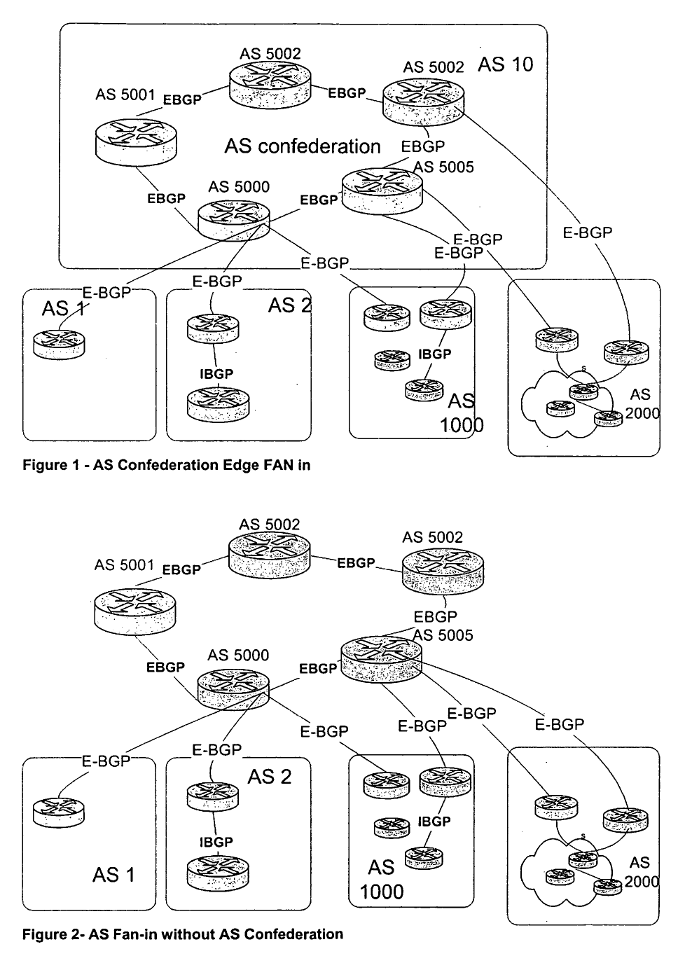

### DETAILED DESCRIPTION OF THE INVENTION

1. Dynamic AS Switching for an AS Confederation Edge

1.1 Overview of Dynamic AS switching for AS Confederation Edge

This mechanism provides a mechanism for an Autonomous System within an AS confederation to survive disconnection from the rest of the Autonomous Systems within the AS Confederation. When an AS is connected to the rest of an AS confederation, it acts as a single AS. If all links between the AS to other members of the AS confederation are broken, the AS Confederation is broken in two (or more) parts, and the individual sub-Autonomous Systems (sub-AS-es) within the confederation may need to “back off” to their local AS number to restore connectivity through some external path.

If a router along the edge of an AS determines the sub-AS has lost its connection to the remainder of the confederation AS, it will need to change the AS number with which it is peering to eBGP peers. This restart of all EBGP connections can be onerous for the AS that has broken away from the AS Confederation. This draft provides a mechanism for the AS within the AS confederation to use a pre-agreed upon fail-over to the internal AS, so its eBGP connections will not be reset.

Upon return of the AS Confederation links, this mechanism can signal the Edge AS returning to the AS Confederation.

1.2 Mechanism overview for Dynamic AS Confederation Switching

The mechanism has two parts:

1) An ASConfed-Edge Capability

The ASConfed-Edge capability signals the ability to fail-over upon “AS confederation disconnect” by changing the local AS number without resetting the eBGP peering session.

The format of the ASConfed-Edge capability is described in section 2 and contains the AS of the Confederation and a list of Internal AS that the BGP peer will back off to. This capability also indicates the mechanism by which the node will signal the switch via the dynamic capabilities.

Note: The detection of the “AS confederation disconnect” is a locally determined feature that includes (but is not limited to): determining that all AS Confederation BGP peers are disconnected from this peer.

2) Signaling the AS Back Off Via Dynamic Capabilities

Signaling an AS fail-over is done via a Dynamic Capability with the ASConfed_Edge capability with AS flag on.

Upon receiving this dynamic capability, the BGP speaker associated with the AS-Confederation Edge switches from the AS confederation to the AS number specified for the session to the internal session.

All checking of the local AS in BGP packets utilizes the new AS.

When the AS Confederations links are re-established, the BGP speaker on the AS Confederation sends a Dynamic Capability with the ASConfed_Edge Capability (with Confed flag on). All AS checking for the local BGP speaker reverts to the original AS.

3. AS Edge Confederation Open Capability

[RFC3992] describes the open capability mechanisms. This document describes a new Capability: ASConfed-Switch:

| | |
|---|---|
| +------------------------------+ | |
| \| Capability Code (1 octet) | \| |
| +------------------------------+ | |
| \| Capability Length (1 octet) | \| |
| +------------------------------+ | |
| \| Capability Value (variable) | \| |
| +------------------------------+ | |

Where the Capability value is:

| | |
|---|---|
| +------------------------------+ | |
| \| Length of AS (1 octet) | \| - length of AS field (2 or 4) |
| +------------------------------+ | |
| \| resend prefix flag (1 octet) | \| - Resend/AS Flag |
| +------------------------------+ | |
| \| AS Confederation number | \| - Confederation AS |
| +------------------------------+ | |
| \| AS internal number 1 | \| - Internal AS 1 |

The resend prefix flag indicates when the AS will resend the routes with the new AS. The flag values are set as a bit pattern to indicate that

0x00—Resend routes based on local timer (may send in groups)

0x01—Resend routes immediately

0x02—Don't resend routes (leave with old AS confederation).

1.3. Capability Message for Dynamic AS Renumbering for AS Confederations

This BGP dynamic capability uses the new BGP Capability format of:

[DYN-CAP]

| | |
|---|---|
| +------------------------------+ | |
| \| Init/Ack (1 bit) | \| |
| +------------------------------+ | |
| \| Ack Request (1 bit) | \| |
| +------------------------------+ | |
| \| Reserved (5 bits) | \| |
| +------------------------------+ | |
| \| Action (1 bit) | \| |
| +------------------------------+ | |
| \| Sequence Number (4 octets) | \| |
| +------------------------------+ | |
| \| Capability Code (1 octet) | \| |
| +------------------------------+ | |
| \| Capability Length (2 octets) | \| |
| +------------------------------+ | |
| \| Capability Value (variable) | \| |
| +------------------------------+ | |

The capability value is:

| | |
|---|---|
| +------------------------------+ | |
| \| Length of AS | \| - length of AS field |
| +------------------------------+ | |
| \| AS in Use (1 octet) | \| - AS in Use |
| +------------------------------+ | |
| \| resend prefix flag (1 octet) | \| - AS State |
| +------------------------------+ | |
| \| AS Confederation number | \| - AS Confederation number |
| +------------------------------+ | |
| \| AS Internal number | \| - Internal AS number |
| +------------------------------+ | |

AS in USE:

0x01—Internal AS number

0x00—AS Confederation number

Resend flag values:

0x00—Resend routes based on local timer (in bataches)

0x01—Resend routes immediately

0x02—Don't resend routes (leave with old AS confederation).

1.4. Security Considerations for Dynamic AS Renumbering on AS Confederation Edge

The security of the exchange is optionally secured by the TCP MD5 key.

Upon discussion with security reviewers, the addition of this feature will neither improve nor detract from the TCP MD5 level of security. The authors considered adding a “cookie” feature to further secure this exchange. Again, review with security experts indicated this “cookied” feature would not improve the security level

2.0 Overview of Dynamic AS Re-Association Mechanisms

This mechanism provides a mechanism for two BGP peers switching AS values within a BGP association without dropping the AS connection.

When two BGP wish to re-configure with a different Autonomous numbers, the current mechanisms in BGP require that the AS drop the connection. If an AS has considerable fan-in of peers, this dropping of the connection to re-associate a new AS may cause significant outages.

This Dynamic AS re-association capability allows two Autonomous Systems and their BGP peers to collude to reset the AS associated with a BGP peer session without dropping the AS connection. The two BGP peers agree upon a fail-over to another AS based on a list of Autonomous Systems.

2.1 Mechanism Overview for Dynamic AS Re-Association

The mechanism has two parts:

1) An Dynamic AS Capability

The Dynamic AS capability signals the ability to use the Dynamic AS Re-association function.

The format of the ASConfed-Edge capability is described in section 2 and contains a list of Autonomous systems that the BGP peer may re-associated to. This capability also indicates the mechanism by which the node will signal the switch is the dynamic capabilities message.

2) Signaling the Dynamic AS Switch-Over

Signaling a Dynamic Switch is done via the Dynamic Capability message with the Dynamic AS capability.

Upon receiving this dynamic capability, the BGP speaker associated with the AS-Confederation Edge process the switch of the peer from the current AS number to the one specified in the capability.

All checking of the local AS in BGP packets utilizes the new AS.

All new routes will be announced with the new AS number. All older routes will be re-announced based on the AS resend flag.

2.2 Dynamic AS Capability

[RFC3992] describes the open capability mechanisms. This document describes a new Capability: Dynamic AS:

| | |
|---|---|
| +------------------------------+ | |
| \| Capability Code (1 octet) | \| |
| +------------------------------+ | |
| Capability Length (1 octet) | \| |
| +------------------------------+ | |
| Capability Value (variable) | \| |
| +------------------------------+ | |

Where the Capability value is:

| | |
|---|---|
| +----------------------------+ | |
| \| Length of AS (1 octet) | \| - length of AS field (2 or 4) |
| +----------------------------+ | |
| \| resend prefix flag (1 octet) | \| - Resend/AS Flag |
| +----------------------------+ | |
| \| Number of AS supported | \| - Number of AS in |

| | re-associate list

| | |
|---|---|
| +----------------------------+ | |
| \| Autonomous System 1 | \| - AS for dynamic re-association |
| +----------------------------+ | |
| \| . . . . . . . . \| | |
| +----------------------------+ | |
| \| Autonomous System n | \| - AS N for dynamic re-association |
| +----------------------------+ | |

The resend prefix flag indicates when the AS will resend the routes with the new AS. The flag values are set as a bit pattern to indicate that

0x00—Resend routes based on local timer (in bataches)

0x01—Resend routes immediately

0x02—Don't resend routes (leave with old AS confederation).

The number of AS supported field gives the number of the Autonomous Systems fin the dynamic re-association list. The Autonomous Systems in the AS list are the list of ASes that this peer may switch to in when dynamically re-association from the original AS to a new AS.

Each side of the peer will send a list of Autonomous Systems that it will dynamic re-associate with. Upon start-up the re-associations list can be check by policy to determine that each side can support the required re-associations.

2.3. Capability Message for Dynamic AS Re-Association

This BGP dynamic capability uses the new BGP Capability format of:

[DYN-CAP]

| | |
|---|---|
| +------------------------------+ | |
| \| Init/Ack (1 bit) | \| |
| +------------------------------+ | |
| \| Ack Request (1 bit) | \| |
| +------------------------------+ | |
| \| Reserved (5 bits) | \| |
| +------------------------------+ | |
| \| Action (1 bit) | \| |
| +------------------------------+ | |
| \| Sequence Number (4 octets) | \| |
| +------------------------------+ | |
| \| Capability Code (1 octet) | \| |
| +------------------------------+ | |
| \| Capability Length (2 octets) | \| |
| +------------------------------+ | |
| \| Capability Value (variable) | \| |
| +------------------------------+ | |

The capability value is:

| | |
|---|---|
| +------------------------------+ | |
| \| Length of AS | \| - length of AS field |
| +------------------------------+ | |
| \| resend prefix flag (1 octet) | \| - AS State |
| +------------------------------+ | |
| \| Current AS number | \| - Old AS number |
| +------------------------------+ | |
| \| New AS number | \| - new AS number |
| +------------------------------+ | |

Resend flag values:

0x00—Resend routes based on local timer

0x01—Resend routes immediately

0x02—Don't resend routes (leave with old AS confederation).

2.4. Security Considerations for Dynamic AS Re-Association

The security of the exchange is optionally secured by the TCP MD5 key.

Upon discussion with security reviewers, the addition of this feature will neither improve nor detract from the TCP MD5 level of security. The authors considered adding a “cookie” feature to further secure this exchange. Again, review with security experts indicated this “cookied” feature would not improve the security level.

The TCP session security will continue across the dynamic BGP peer re-association. The TCP sessions dynamic MD5 re-association or key switch would also allow TCP sessions to continue for a long period.

1. A border gateway protocol routing system comprising:
an autonomous system within an autonomous system confederation configured to survive disconnections from one or more other autonomous systems within the autonomous system confederation.
